(19) United States
(12) Patent Application Publication
(10) Pub. No.: US 2003/0028493 A1
(43) Pub. Date: Feb. 6, 2003

(54) Personal information management system, personal information management method, and information processing server

(75) Inventors: Yuichi Tajima, Tokyo (JP); Taneaki Chiba, Tokyo (JP); Shigeru Kawabe, Tokyo (JP); Norihisa Mitsuyu, Tokyo (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/202,320

(22) Filed: Jul. 24, 2002

(30) Foreign Application Priority Data
Aug. 3, 2001 (JP) 2001-236726

(51) Int. Cl. G06F 17/60

(52) U.S. Cl. 705/67

(57) ABSTRACT

Personal information that is registered with areas that can be connected to the Internet is divided into a plurality of data portions, which are then each registered with areas that are under different control. When a request to acquire this personal information is subsequently issued, the data portions that are registered with areas under different control are combined to restore the personal information.

### BACKGROUND OF THE INVENTION

1. Field of the Invention

The present invention relates to a personal information management system and a personal information management method for managing personal information by means of areas that are connectible to the Internet.

2. Description of the Related Art

With the recent rapid popularization of the Internet and personal computers, individuals can easily connect to the Internet at any time and from any location. This development has also seen the rapid increase of businesses that establish home pages on the Internet and that, by means of these home pages, provide information and market goods.

In online shopping, for example, a home page can be used to market goods whereby goods or services can be easily purchased from the home, and the number of users has therefore been increasing.

When a user purchases goods in typical online shopping, the user first selects a desired article or service from among articles and services that are displayed on a terminal such as a personal computer, following which the user both enters customer information that includes, for example, the user's name, address, telephone number, and e-mail address, and selects the method of payment.

After the user confirms the purchase articles, the payment method, and the content of the customer information that have been determined by the above-described method, an order is placed for the article.

As shown in FIG. 1, a typical online shopping system is made up by: user terminal 510 that is connectible to Internet 550; service provider 530a to which user terminal 510 subscribes and that handles connections of user terminal 510 to Internet 550; store 520 that markets goods; and service provider 530b to which store 520 subscribes and that handles connections of a terminal (not shown in the figure) provided in store 520 to Internet 550. In addition, a terminal that is configured to allow connection to Internet 550, and database 521, in which is registered personal information relating to the user of user terminal 510, are provided at store 520.

Referring now to FIG. 2, the process when using online shopping in an online shopping system that is configured as described hereinabove is next described taking as an example the process by which the user of user terminal 510 purchases an article that is handled by store 520.

When the user of user terminal 510 purchases an article that is handled by store 520, the user first uses user terminal 510 to access the shopping site that is operated by store 520 in Step S101.

Then, in Step S102, the shopping site that is operated by store 520 is transmitted from store 520.

In Step S103, the shopping site that has been transmitted from store 520 is received by user terminal 510 by way of Internet 550 and displayed.

The user of user terminal 510 views the shopping site that is displayed on user terminal 510 and selects a desired article in Step S104.

In Step S105, the user of user terminal 510 enters, in prescribed areas in the shopping site that is displayed on user terminal 510, either personal information such as the user's name, address, telephone number, electronic mail address, or an ID and a password that have been issued by store 520. Here, the input of information in Step S105 involves entering personal information if the user of user terminal 510 has not registered personal information with store 520. If the user of user terminal 510 has already registered personal information with store 520, a password and an ID for recognizing the user of user terminal 510 have been issued from store 520, and the input of information in Step S105 therefore involves entering the ID and password.

In Step S106, the user of user terminal 510 creates an order form by selecting the article in Step S104 and entering the information in Step S105 and transmits the order form to store 520.

Store 520, upon receiving the order form that has been transmitted from user terminal 510 by way of Internet 550 in Step S107, determines whether an ID and password or personal information has been entered on order form in Step S108.

If personal information has been entered in the order form, store 520 both registers the personal information with database 521 in Step S109 and issues an ID and password that can identify the user of user terminal 510 to the user in Step S110. The personal information is also registered with database 521 in association with the ID and password that were issued.

The user of user terminal 510 accepts the ID and password that were issued by store 520 by receiving this information by means of user terminal 510 in Step S111. When subsequently using online shopping by means of the shopping site that is operated by store 520, a user that has accepted an ID and password produces an order form by entering the ID and password that were accepted in Step S111 without entering personal information in the shopping site.

Store 520 then ships the article and requests payment for the article in Step S112 based on the order form that was received in Step S107.

In Step S113, the user of user terminal 510 receives the article that is sent from store 520 and pays for the article.

Alternatively, if an ID and password are entered on the order form that is received by store 520 from user terminal 510 in Step S107, store 520 determines whether the ID and password that have been entered on the order form are correct or not in Step S114.

If the ID and password that have been entered on the order form are correct, store 520 acquires the personal information that corresponds to the ID and password from database 521 in Step S115.

Store 520 then proceeds with the process in Step S112 and sends the article and requests payment based on the personal information that was acquired from database 521 and the order form that was received in Step S107.

If the ID and password that have been entered on the order form are incorrect, store 520 then reports this fact to the user of user terminal 510 in Steps S116 and S117.

In the online shopping system according to the above-described explanation, personal information is registered with database 521 provided in store 520 such that a user that has once used the online shopping need not re-enter personal information when subsequently taking advantage of online shopping. However, this registration of personal information is necessary for each online shopping site that a user uses, and the registration of personal information in the databases of each store not only takes time and effort but also increases the possibility that personal information will be stolen.

In addition, the security measures that are taken in personal information management in online shopping cannot be considered absolutely sufficient, and there is a great possibility that personal information may be divulged due to unauthorized access from the outside or unauthorized access by persons within the system.

A technology in which a public key cryptosystem is used to exchange information has been employed in recent years to improve the security of information exchange over the Internet.

As shown in FIG. 3, an example of the prior art is constituted by: user terminal 510 that is connectible to Internet 550; service provider 530 for handling connections of user terminal 510 to Internet 550; certificate authority 540 for certifying personal information relating to the user of user terminal 510 and a public key that is registered in advance; and directory 560 in which is registered the public key that the user of user terminal 510 has registered in advance in certificate authority 540.

The following explanation describes the process when information is exchanged in the information processing system that is constituted according to the foregoing description.

Referring to FIG. 4, we first describe the process of registering the user of user terminal 510 with certificate authority 540.

In Step S121, the user of user terminal 510 first uses user terminal 510 to create a secret key and a public key, these keys constituting a set in the public key system. In Step S122, this public key and personal information that is composed of an electronic mail address or address are submitted to certificate authority 540. The submission of the public key and personal information to certificate authority 540 may be realized by way of Internet 550 using user terminal 510 or by the user of user terminal 10 sending ordinary mail.

Certificate authority 540, after receiving the public key and personal information in Step S123, checks whether the received personal information is correct or not in Step S124. The check of this personal information is effected by a method such as sending a password by electronic mail to the electronic mail address that is included in the personal information or mailing a password to the address that is included in the personal information and then checking whether the password has been correctly received by the user.

If it has been affirmed in Step S124 that the personal information received from the user is correct, certificate authority 540 issues a certificate in Step S125 certifying that the minimum necessary information that can identify the user within the personal information that was received in Step S123 and a public key belong to the user of user terminal 510 and sends this certificate together with the public key to the user of user terminal 510.

The user of user terminal 510 receives the certificate that was sent from certificate authority 540 in Step S126.

In Step S127, certificate authority 540 registers with directory 560 the public key that was received in Step S123 and the certificate that was issued in Step S125 and makes this information open.

However, if it determined in Step S124 that the personal information received from the user is incorrect, certificate authority 540 notifies the user of user terminal 510 that the personal information is incorrect in Steps S128 and S129.

Personal information that is registered with database 541 that is provided to certificate authority 540 is registered with areas that are closed to the outside by the access control function of the server or a firewall and cannot be viewed from the outside.

Next, regarding the method of using certificate authority 540, when a user that has registered with certificate authority 540 by means of the series of processes shown in FIG. 4 sends desired information by way of Internet 550, the information that is sent is encrypted using a secret key and the encrypted information is then sent to a destination by way of Internet 550.

At the destination of the information, the user's public key is acquired from directory 560 and the acquired public key is used to decrypt the encrypted information, whereby it is confirmed that the received information was created by the user of user terminal 510.

The exchange of information by means of this type of public key cryptosystem is used when, for example, a sender must be identified in an important transaction or to avoid a denial after a transaction.

Registering the personal information of user terminal 510 with certificate authority 540 such as shown in FIG. 3 and then using the personal information in online shopping such as shown in FIG. 1 not only can eliminate the above-described time and trouble of entering personal information for each online shopping site that the user uses, but can also reduce the possibility of theft of personal information.

However, if the above-described personal information relating to a user is registered with one area that is connectible to the Internet, there is the danger that, because the information registered with one area as a contiguous data file, this information may be viewed by unauthorized access from the outside through a security hole or by unauthorized access by someone inside the system, even though the information is registered with an area that is closed to the outside by means of the access control function of a server or a firewall.

Alternatively, a method may be employed in which personal information relating to a user is registered with an encrypted state. In such cases, however, the danger still remains that, even though the content of the registered personal information is encrypted and thus cannot be viewed even when stolen, given enough time, a high-speed computer may be used to decrypt the encrypted personal information.

### SUMMARY OF THE INVENTION

It is an object of the present invention to provide a personal information management system, a personal information management method, and a server that can improve the security of personal information that is registered with areas that are connectible to the Internet.

In the present invention, when a user registers personal information with an area that is connectible to the Internet, the personal information that is to be registered and a public key with a public key system are submitted to an authentication means or a service provider. The authentication means checks whether the submitted personal information is correct or not, and if the personal information is determined to be correct, the personal information and the public key are certified to be the user's.

The authentication means or service provider divides the submitted personal information into a plurality of data portions, registers at least one of the plurality of data portions with a database that is provided in the authentication means or service provider, and registers the other data portions with other areas that are connectible to the Internet and that are under control that is separate from the authentication means or service provider. Here, the authentication means or service provider either saves link information that indicates the registration destinations of the other data portions or attaches link information to data portions that are registered with the database that is provided in the authentication means or service provider.

When a request that is certified by means of the public key cryptosystem to acquire the personal information is subsequently sent in from a terminal that is connectible to the Internet, the authentication means or service provider: retrieves the data that are registered with the database of the authentication means or service provider, identifies the registration destinations of the other data portions based on the saved link information, acquires the other data portions from the registration destinations of the other data portions, combines these data portions to restore the personal information, and sends the restored personal information to the terminal.

Thus, because personal information that is registered with areas that are connectible to the Internet is divided into a plurality of data portions and then registered with areas that are each under separate control, the personal information cannot be viewed unless all of the areas in which data are registered are exposed, and an improvement can therefore be obtained in the security of personal information that is registered with areas that are connectible to the Internet.

The above and other objects, features, and advantages of the present invention will become apparent from the following description with reference to the accompanying drawings, which illustrate examples of the present invention.

### BRIEF DESCRIPTION OF THE DRAWINGS

FIG. 1 shows an example of a typical online shopping system.

FIG. 2 is a flow chart for explaining processing when using online shopping in the online shopping system shown in FIG. 1.

FIG. 3 shows an example of the configuration of an information processing system that employs the public key cryptosystem.

FIG. 4 is a flow chart, for explaining the process of registering the user of a user terminal to a certificate authority with the information processing system shown in FIG. 3.

FIG. 5 shows the first embodiment of the personal information management system of the present invention.

FIG. 6 is a flow chart for explaining processing when the user of a user terminal registers personal information to a certificate authority with the personal information management system shown in FIG. 5.

FIG. 7 is a flow chart for explaining processing when the user of a user terminal uses personal information that is registered with the certificate authority to purchase an article that is handled by a store in the personal information management system shown in FIG. 5.

FIG. 8 is for explaining an example of the method of dividing personal information in the personal information management system shown in FIG. 5.

FIG. 9 is for explaining another example of a method of dividing personal information in the personal information management system shown in FIG. 5.

FIG. 10 is for explaining another example of a method of dividing personal information in the personal information management system shown in FIG. 5.

FIG. 11 is for explaining another example of a method of dividing personal information in the personal information management system shown in FIG. 5.

FIG. 12 is for explaining another example of a method of dividing personal information in the personal information management system shown in FIG. 5.

FIG. 13 is for explaining another example of a method of dividing personal information in the personal information management system shown in FIG. 5.

FIG. 14 shows the second embodiment of the personal information management system of the present invention.

FIG. 15 is a flow chart for explaining processing when the user of a user terminal registers personal information with the personal information management system shown in FIG. 14.

FIG. 16 is a flow chart for explaining processing when the user of a user terminal uses personal information that is registered with a service provider and certificate authority to purchase an article that is handled by a store in the personal information management system that is shown in FIG. 14.

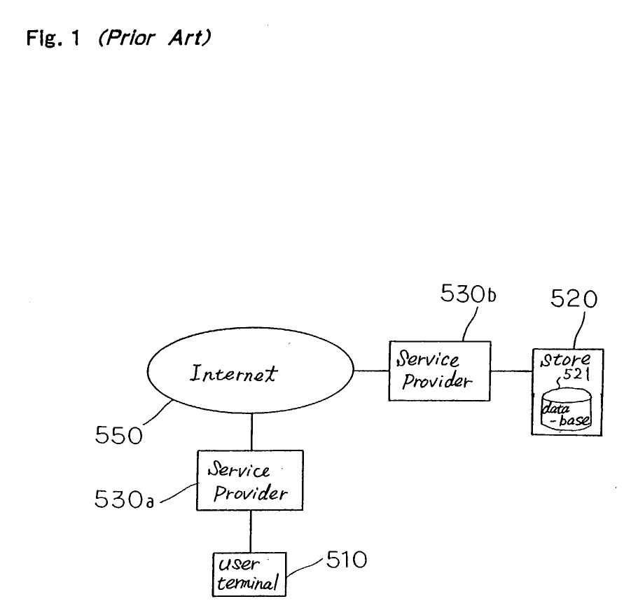

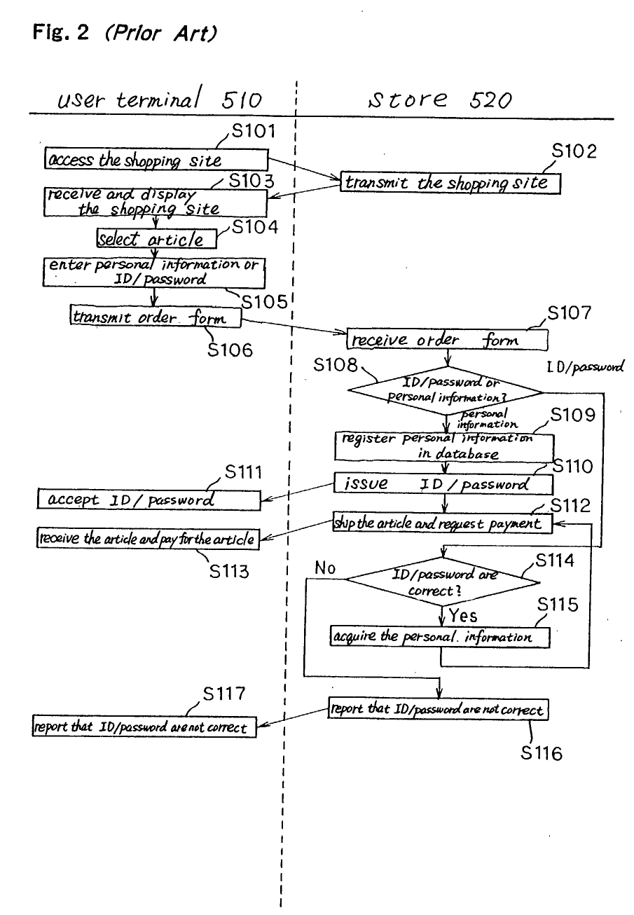

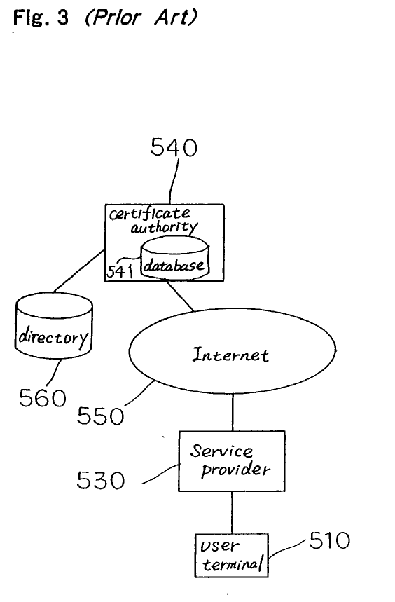

### DETAILED DESCRIPTION OF THE PREFERRED EMBODIMENTS

(First Embodiment)

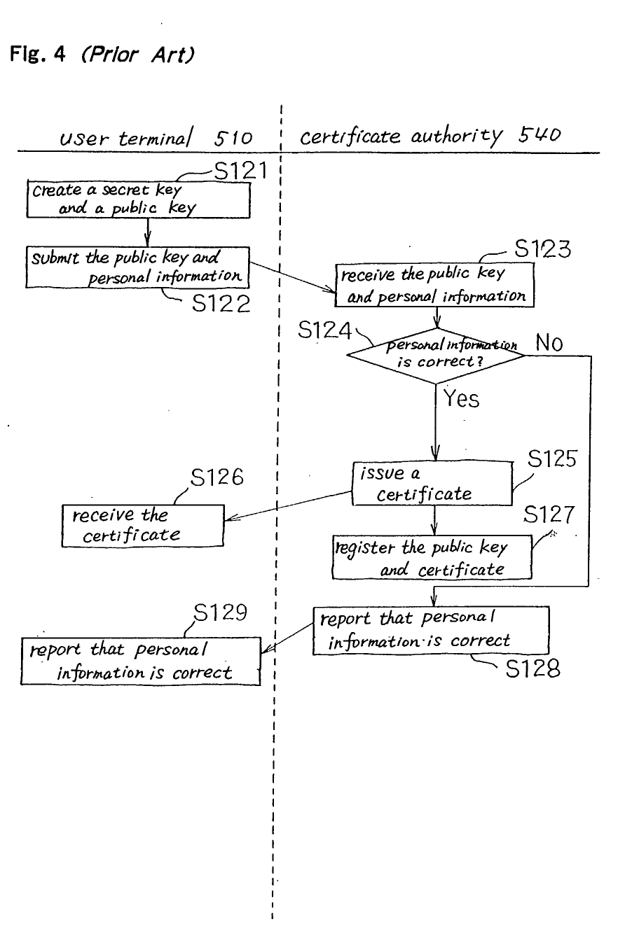

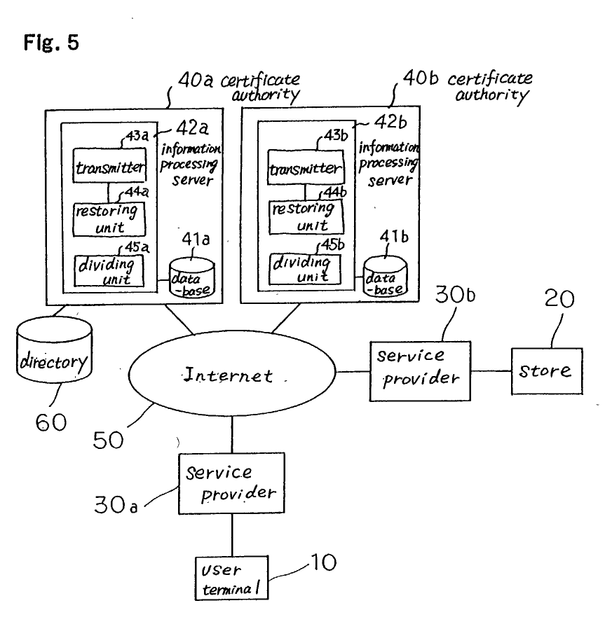

As shown in FIG. 5, this embodiment is made up by: user terminal 10 that is connectible to Internet 50; service provider 30a to which user terminal 10 subscribes for handling connections of user terminal 10 to Internet 50; store 20 that markets goods and that is provided with a terminal (not shown in the figure) that is configured so as to allow connection to Internet 50; service provider 30b to which store 20 subscribes for handling connections of the terminal of store 20 to Internet 50; certificate authority 40a for both certifying personal information relating to the user of user terminal 10 and registering a portion of the personal information relating to the user of user terminal 10; certificate authority 40b that is configured so as to allow connection to certificate authority 40a by way of Internet 50 for registering a portion of the personal information that relates to the user of user terminal 10; and directory 60 for registering a public key that the user of user terminal 10 has registered with certificate authority 40a in advance. In addition, certificate authority 40a includes information processing server 42a that is made up by: dividing unit 45a for dividing the personal information relating to the user of user terminal 10, registering a portion of this information with database 41a, and sending to certificate authority 40b by way of Internet 50 the portion of the divided personal information that is not registered with database 41a; restoring unit 44a for authenticating a user by means information that is sent in from store 20 and combining the portion of personal information that is registered with database 41a with the portion of personal information that has been sent to certificate authority 40b and registered with database 41b that is included in certificate authority 40b to restore the personal information; and transmitter 43a for sending the restored personal information to store 20 by way of Internet 50. Certificate authority 40b may also be a device that lacks an authentication function.

The personal information management method in a personal information management system that is constituted as described above is next described by taking an example of the processing when the user of user terminal 10 purchases an article that is handled by store 20. The processing in certificate authorities 40a and 40b that is described below may be performed in each of information processing servers 42a and 42b that are provided in certificate authorities 40a and 40b.

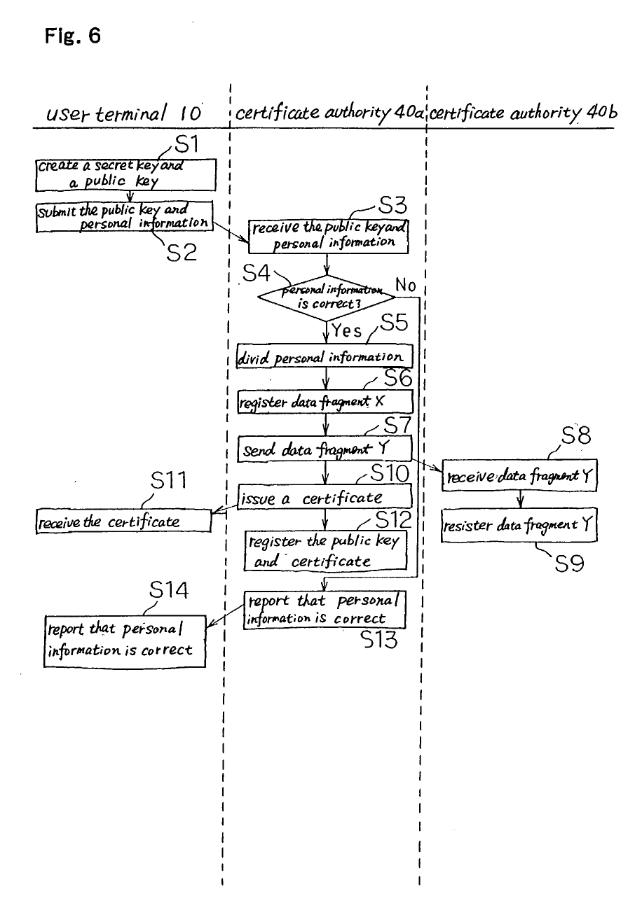

Referring to FIG. 6, the process when the user of user terminal 10 registers personal information with certificate authority 40a is first explained. The exchange of information by way of Internet 50 described below is carried out in a state in which the information that is exchanged is all encrypted by a means such as an SSL (Secure Sockets Layer).

In Step S1, the user of user terminal 10 first uses user terminal 10 to create a public key and secret key that make up one set in a public key cryptosystem, and further, submits this public key and personal information that is composed of, for example, an electronic mail address or residence address, to certificate authority 40a in Step S2. This submission of public key and personal information to certificate authority 40a may be realized by using user terminal 10 to send by way of Internet 50 or by the user of user terminal 10 simply sending by ordinary mail.

Upon receiving the public key and personal information in Step S3, certificate authority 40a checks whether the received personal information is correct or not in Step S4. This checking of personal information is realized by a method such as sending a password by means of electronic mail to the electronic mail address that is included in the personal information or by means of ordinary mail to the address that is included in the personal information and then checking whether the password correctly reaches the user.

If it is confirmed that the personal information received from the user is correct in Step S4, certificate authority 40a divides, by means of a prescribed dividing method, the personal information that have been received from the user into two data fragments in Step S5. The division of the personal information is implemented such that each data fragment is completely unintelligible when taken independently. The details of the dividing method will be described hereinbelow.

Certificate authority 40a registers one of the data fragments of the divided personal information (hereinbelow referred to as “data fragment X”) with database 41a in Step S6, and further, sends the other data fragment (hereinbelow referred to as “data fragment Y”) to certificate authority 40b by way of Internet 50 in Step S7. At this time, the address of certificate authority 40b that is the registration destination of data fragment Y and identification information that can identify certificate authority 40b are held in certificate authority 40a as link information.

Certificate authority 40b, having received data fragment Y that was sent in from certificate authority 40a in Step S8, registers received data fragment Y with database 41b in certificate authority 40b in Step S9.

In addition, certificate authority 40a issues a certificate in Step S10 that certifies that the public key and, of the personal information that was received in Step S3, the minimum necessary information that can identify the user, belong to the user of user terminal 10, and further, sends this certificate to the user of user terminal 10 together with the public key.

The user of user terminal 10 receives the certificate that was sent from certificate authority 40a in Step S1.

In Step S12, certificate authority 40a registers the public key that was received in Step S3 and the certificate that was issued in Step S10 in directory 60 and makes the public key and certificate public.

If, however, the personal information that was received from the user is determined to be incorrect in Step S4, the user is notified that the personal information is incorrect in Steps S13 and S14.

The data fragments that are registered with databases 41a and 41b that are included in certificate authorities 40a and 40b, respectively, are registered with areas that are closed to the outside by means of the access control function of the server or firewall and therefore cannot be viewed from the outside.

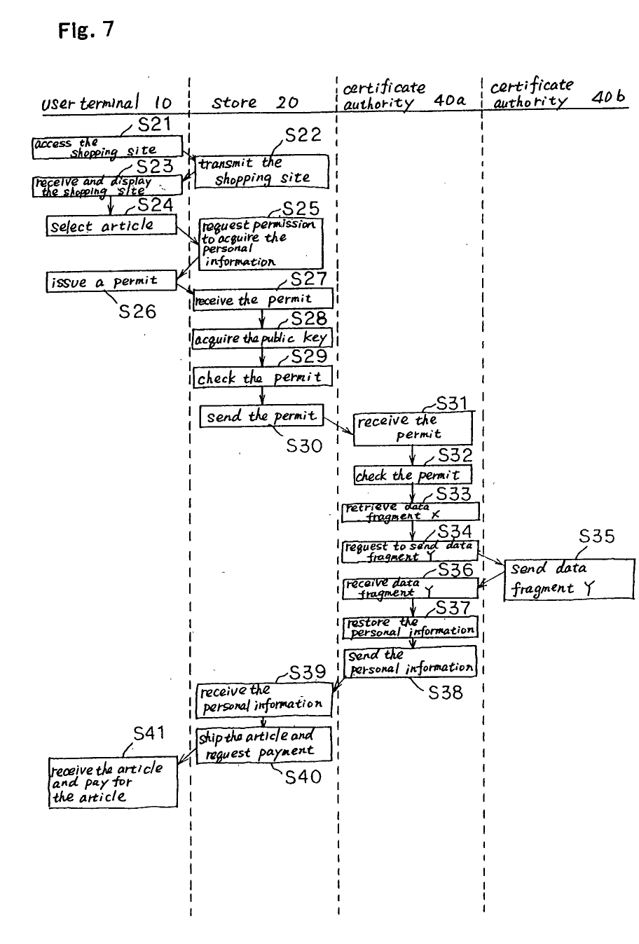

Referring now to FIG. 7, explanation is presented regarding the process when the user of user terminal 10 uses the personal information that is registered with certificate authorities 40a and 40b to purchase an article that is handled by store 20.

When the user of user terminal 10 purchases an article that is handled by store 20, the user first uses user terminal 10 to access the shopping site that is operated by store 20 in Step S21.

The shopping site that is operated by store 20 is then sent from store 20 in Step S22.

The shopping site that has been sent from store 20 is next received by way of Internet 50 and displayed on user terminal 10 in Step S23.

The user of user terminal 10 next views the shopping site that is displayed on user terminal 10 and selects a desired article in Step S24.

In Step S25, store 20 lists the items of personal information that are necessary when ordering the article that was selected by the user in Step S24 and requests permission from the user of user terminal 10 to acquire from certificate authority 40a the personal information that relates to the user of user terminal 10 regarding these items.

When the user of user terminal 10 has checked the items that have been sent from store 20 and has granted permission for store 20 to acquire personal information relating to the user of user terminal 10 for these items, the user creates a permit indicating this permission, compresses the created permit, and further, uses the secret key that was created in Step S1 (see FIG. 6) to encrypt the compressed permit, and sends this encrypted permit together with the created permit to store 20 in Step S26.

Store 20, having received the permit that was sent from user terminal 10 by way of Internet 50 in Step S27, acquires the public key that was registered by the user of user terminal 10 from directory 60 in Step S28.

Store 20 then uses the acquired public key to check whether the received permit was created by the user of user terminal 10 in Step S29. It is also possible for the user terminal 10 to send the user's public key to store 20 together with the created permit and the encrypted permit and for store 20 to use the public key that was sent in from user terminal 10 to check the permit. In this case, store 20 does not need to acquire the public key from directory 60.

Next, regarding the details for checking the permit in Step S29, store 20 first uses the public key that was acquired in Step S28 to decrypt the encrypted permit of the permits that were received in Step S27. The permit that was sent in from user terminal 10 together with the encrypted permit is then compressed and this compressed permit is then collated with the decrypted permit. If the results of collation show that the two permits match, it is confirmed that the permit that was received in Step S27 is a permit that was created by the user of user terminal 10. The public key that store 20 has acquired from directory 60 is certified as belonging to the user of user terminal 10 by the certificate that was issued by certificate authority 40a.

If the received permit is confirmed to have been created by the user of user terminal 10 in Step S29, store 20 sends the permit and the encrypted permit that were received from user terminal 10 to certificate authority 40a in Step S30.

Certificate authority 40a, having received the permits that have been sent in from store 20 by way of Internet 50 in Step S31, uses the public key of the user of user terminal 10 that is registered with directory 60 to check whether or not the received permit was created by the user of user terminal 10 in Step S32. This checking of the permit is also carried out similar to the checking of the permit at store 20. As with the checking of the permit at store 20, the checking of the permit at certificate authority 40a may also be realized by sending the user's public key from store 20 and then using the public key that was sent from store 20 at certificate authority 40a.

If it is confirmed in Step S32 that the received permit was created by the user of user terminal 10, certificate authority 40a retrieves data fragment X of the personal information relating to the user of user terminal 10 from database 41a in Step S33.

Here, certificate authority 40a holds, as link information, identification information that can identify certificate authority 40b or the address of certificate authority 40b that is the registration destination of data fragment Y, which, by combination with fragment X that has been retrieved from database 41a, becomes the personal information relating to the user of user terminal 10. Based on this link information, certificate authority 40a requests certificate authority 40b, which is the registration destination of data fragment Y, to send data fragment Y in Step S34. When the link information that is held by certificate authority 40a is identification information that can identify certificate authority 40b, a database for placing this identification information and the address of certificate authority 40b in correspondence is further required. This link information may also be encrypted and held.

Certificate authority 40b, having received the request from certificate authority 40a, retrieves data fragment Y from within database 41b and sends data fragment Y to certificate authority 40a in Step S35.

Certificate authority 40a, having received data fragment Y from certificate authority 40b in Step S36, combines data fragment X that has been retrieved from database 41a and data fragment Y that has been sent in from certificate authority 40b to restore the personal information relating to the user of user terminal 10. In addition, information relating to the method of dividing the personal information and to the method of arranging the divided data when dividing the personal information in Step S5 (see FIG. 6) is attached to each of data fragments X and Y, and certificate authority 40a combines data fragment X and data fragment Y based the information relating to the method of dividing and method of arranging that is attached to data fragments X and Y.

Of the restored personal information, certificate authority 40a sends to store 20 only the personal information relating to the items that were listed by store 20 in Step S38.

Store 20, after receiving the personal information relating to the user of user terminal 10 that has been sent from certificate authority 40a in Step S39, ships the article and bills for the article in Step S40 based on the received personal information and information of the article that was selected in Step S24.

The user of user terminal 10 then receives the article that was shipped from store 20 and pays for the article in Step S41.

When the transaction for the article has been completed, the personal information that was acquired from certificate authority 40a is deleted at store 20.

Details regarding the method of dividing personal information are next explained for a plurality of examples.

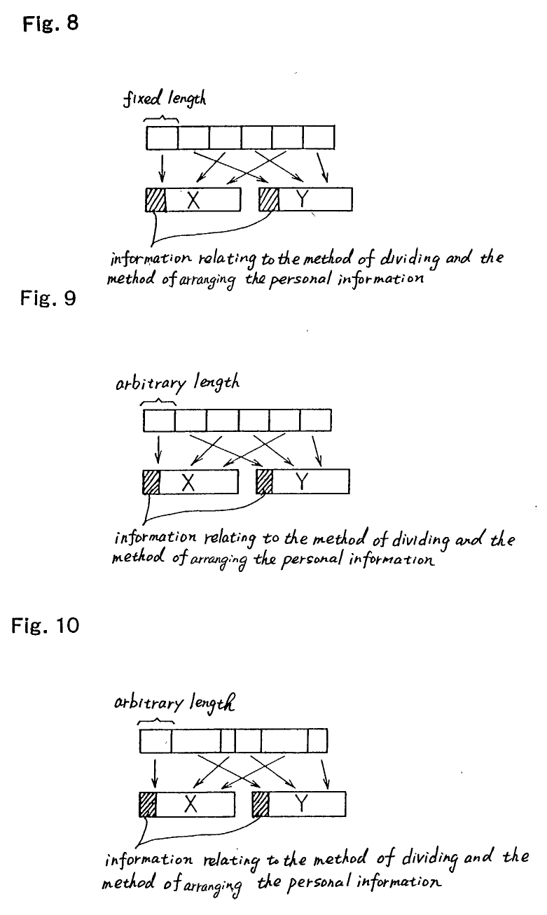

As one example of a method of dividing personal information, personal information that the user of user terminal 10 has submitted to certificate authority 40a is first divided into a plurality of data portions each of a predetermined fixed length, and this plurality of data portions is then arranged as two data fragments, data fragment X and data fragment Y, according to a set method of arranging, as shown in FIG. 8. Data fragment X is then registered with database 41a of certificate authority 40a, and data fragment Y is registered with database 41b of certificate authority 40b.

In this case, information relating to the method of dividing and the method of arranging the personal information is attached to each of data fragments X and Y, but because the personal information is divided into data portions of predetermined fixed length in this example, this information is not absolutely necessary.

As another example of the method of dividing personal information, the personal information that is submitted to certificate authority 40a by the user of user terminal 10 is divided into a plurality of data portions each of equal arbitrary length according to a function of, for example, random numbers, time, or file capacity, and this plurality of data portions is then arranged into two data fragments, data fragment X and data fragment Y, according to a set method of arranging, as shown in FIG. 9. Data fragment X is then registered with database 41a of certificate authority 40a, and data fragment Y is registered with database 41b of certificate authority 40b.

Because the personal information is divided into data portions of an arbitrary length in this case, the arbitrary length, which is information relating to the method of dividing and the method of arranging, must be attached to data fragments X and Y.

When data fragment X and data fragment Y that have been divided in this manner are combined, data fragment X and data fragment Y are combined based on the information relating to the method of dividing and the method of arranging that is attached to each of data fragments X and Y.

According to yet another method of dividing personal information, personal information that is submitted by the user of user terminal 10 to certificate authority 40a is first divided into a plurality of data portions each of different arbitrary length according to a function of, for example, random numbers, time, or file capacity, and this plurality of data portions is then arranged into two data fragments, data fragment X and data fragment Y, according to a set method of arrangement, as shown in FIG. 10. Data fragment X is then registered with database 41a of certificate authority 40a, and data fragment Y is registered with database 41b of certificate authority 40b.

Because the personal information is divided into data portions of different arbitrary lengths in this case, the arbitrary lengths, which is information relating to the method of dividing and method of arranging, must be attached to each of data fragments X and Y.

When combining data fragment X and data fragment Y that have been divided by this method, data fragment X and data fragment Y are combined based on the information relating to the method of dividing and the method of arranging that is attached to each of data fragments X and Y. In each of the three methods described in the foregoing explanation, the personal information may also be encrypted and then registered.

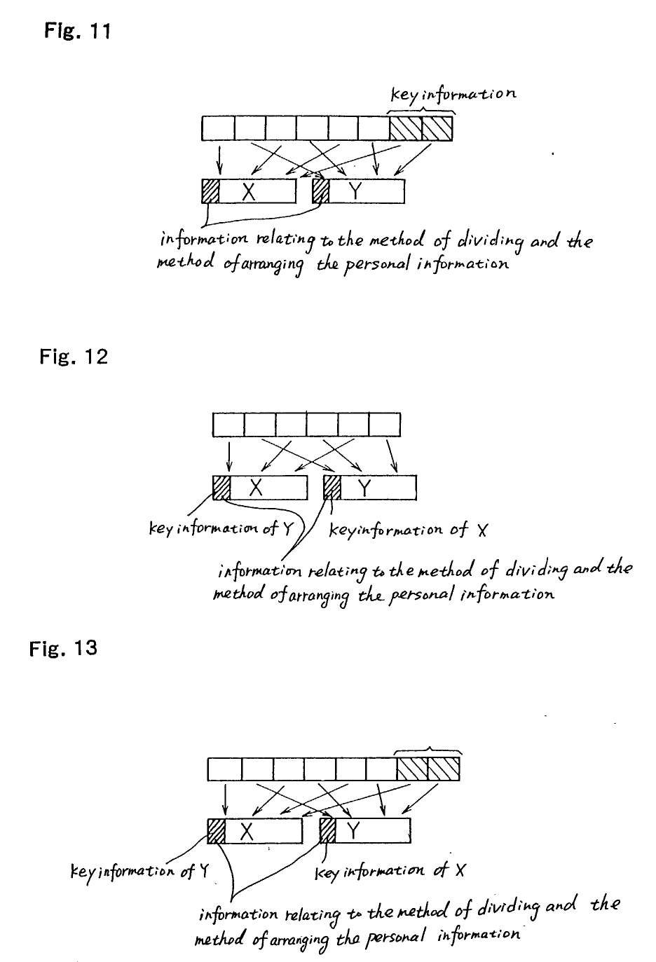

As still another example of a method of dividing personal information, as shown in FIG. 11, personal information that has been submitted to certificate authority 40a by the user of user terminal 10 is first encrypted, and the encrypted personal information and information regarding the key that is used in the encryption are then divided into a plurality of data portions each of fixed length as shown in FIG. 8, or of arbitrary length as shown in FIG. 9 or FIG. 10. The plurality of data portions are then arranged into two data fragments, data fragment X and data fragment Y, according to a set method of arrangement, and data fragment X is then registered with database 41a of certificate authority 40a and data fragment Y is registered with database 41b of certificate authority 40b.

When combining data fragment X and data fragment Y that have been divided in this way, data fragment X and data fragment Y are combined based on information relating to the method of dividing and the method of arranging if information relating to the method of dividing and the method of arranging has been attached to data fragments X and Y, and the key information that was attached to the encrypted personal information is then used to decrypt the encrypted personal information.

As yet another example of a method of dividing personal information, as shown in FIG. 12, personal information that has been submitted to certificate authority 40a by the user of user terminal 10 is first divided into a plurality of data portions each of fixed length as shown in FIG. 8 or of arbitrary length as shown in FIG. 9 or FIG. 10, and this plurality of data portions is then arranged into two data fragments, data fragment X and data fragment Y, according to a set method of arrangement. Data fragments X and Y are then each encrypted, and encrypted data fragment X is then registered with database 41a of certificate authority 40a and encrypted data fragment Y is registered with database 41b of certificate authority 40b. Information regarding the key that was used for the encryption of data fragment Y is attached to encrypted data fragment X, and information regarding the key that was used in the encryption of data fragment X is attached to encrypted data fragment Y.

When combining data fragment X and data fragment Y that have been divided in this way, key information that has been attached to the encrypted data fragment X is used to decrypt data fragment Y, and key information that has been attached to encrypted data fragment Y is used to decrypt data fragment X. Then, if information relating to the method of dividing and method of arranging is attached to data fragments X and Y, data fragment X and data fragment Y are combined based on this information relating to the method of dividing and method of arranging.

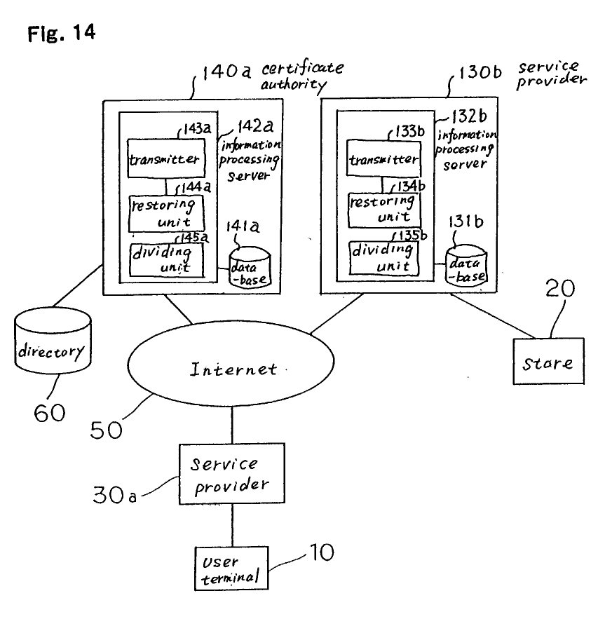

As yet another method of dividing personal information, as shown in FIG. 13, personal information that the user of user terminal 10 has submitted to certificate authority 40a is first encrypted, and the encrypted personal information and information on the key that was used in encrypting the personal information are then divided into a plurality of data portions, each of fixed length as shown in FIG. 8 or of arbitrary length as shown in FIG. 9 or FIG. 10. This plurality of data portions is then arranged into two data fragments, data fragment X and data fragment Y, according to a set method of arrangement, and further, data fragment X and data fragment Y are each encrypted. The encrypted data fragment X is then registered with database 41a of certificate authority 40a and the encrypted data fragment Y is registered with database 41b of certificate authority 40b. Information regarding the key that was used to encrypt data fragment Y is attached to encrypted data fragment X, and information regarding the key that was used to encrypt data fragment X is attached to encrypted data fragment Y.

When combining data fragment X and data fragment Y that have been divided in this way, the key information that was attached to encrypted data fragment X is used to decrypt data fragment Y, and the key information that was attached to encrypted data fragment Y is used to decrypt data fragment X. Then, if information relating to the method of dividing and method of arranging is attached to data fragments X and Y, data fragment X and data fragment Y are combined based on this information relating to the method of dividing and method of arranging, and further, the key information that is attached to the combined personal information is used to decrypt the encrypted personal information.

In this embodiment, data fragment X in which personal information has been divided is registered with certificate authority 40a, and data fragment Y is registered with certificate authority 40b that is different from certificate authority 40a, but the registration destination of data fragment Y may also be another network that is constituted by a service provider or certificate authority 40a.

It is also possible to hold in certificate authority 40a only link information that indicates the registration destination of the divided data fragments without registering the divided data fragments, and to register the divided data fragments in each of a plurality of other areas that are connectible to Internet 50 and that include certificate authority 40b.

(Second Embodiment)

Referring now to FIG. 14, the second embodiment is made up by: user terminal 10 that is connectable to Internet 50; service provider 30a to which user terminal 10 subscribes for handling connections of user terminal 10 to Internet 50; store 20 that markets goods and that is provided with a terminal (not shown in the figure) that is configured to allow connection to Internet 50; service provider 130b to which store 20 subscribes for both handling connections of the terminal of store 20 to Internet 50 and for registering a portion of personal information that relates to the user of user terminal 10; certificate authority 140a that is configured to allow connection to service provider 130b by way of Internet 50 for registering a portion of the personal information relating to the user of user terminal 10; and director 60 for registering a public key that the user of user terminal 10 has registered in advance. Service provider 130b further includes information processing server 132b that is constituted by: dividing unit 135b for dividing the personal information relating to the user of user terminal 10, registering a portion of this personal information with database 131b, and sending the portion of the divided personal information that is not registered with database 131b to certificate authority 140a by way of Internet 50; restoring unit 134b for authenticating a user by means of information that is sent in from store 20, combining the portion of personal information that has been registered with database 131b and the portion of personal information that has been sent to certificate authority 140a and registered with database 141a that is included in certificate authority 140a to restore the personal information; and transmitter 133b for sending the restored personal information to store 20.

Explanation is next presented regarding the personal information management method in the personal information management system that is configured as described above, taking as an example the processing when the user of user terminal 10 purchases an article that is handled by store 20. The processing in service provider 130b and certificate authority 140a that is described below is performed in information processing servers 132b and 142b that are provided in service provider 130b and certificate authority 140a, respectively.

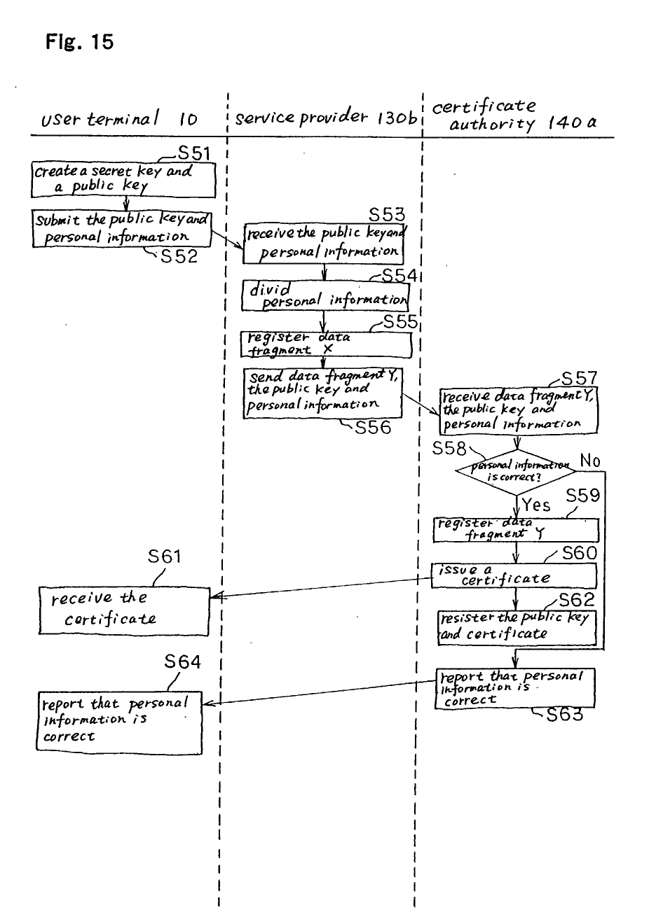

The processing that is carried out when the user of user terminal 10 registers personal information is first explained with reference to FIG. 15. The exchange of information by way of Internet 50 that is shown hereinbelow may be carried out in a state in which all of the exchanged information is encrypted by a means such as an SSL (Secure Sockets Layer).

The user of user terminal 10 first uses user terminal 10 to create a public key and a secret key that constitute a set in a public key cryptosystem in Step S51, and in addition, to submit this public key and personal information that is composed of, for example, an electronic mail address or residence address, to service provider 130b in Step S52. The submission of the public key and the personal information to service provider 130b may be realized by way of Internet 50 using user terminal 10 or by the user of user terminal 10 simply sending by ordinary mail.

Service provider 130b, having received the public key and personal information in Step S53, divides the personal information that was received from the user into two data fragments by a prescribed method of dividing in Step S54. The division of personal information is implemented by any of the methods shown in FIGS. 8 to 13 such that the data fragments are each completely unintelligible when taken independently.

Service provider 130b registers one data fragment (hereinbelow referred to as “data fragment X”) of the divided personal information with database 131b in Step S55, and sends to certificate authority 140a the other data fragment (hereinbelow referred to as “data fragment Y”) as well as the public key and personal information that were received from the user in Step S53 by way of Internet 50 in Step S56. At this time, the address of certificate authority 140a, which is the registration destination of data fragment Y, or identification information that can identify certificate authority 140a is held as link information in service provider 130b. Certificate authority 140a, having received data fragment Y, personal information, and public key that have been sent in from service provider 130b in Step S57, checks whether the received personal information is correct or not in Step S58. This check of the personal information is realized by a method of, for example, sending a password by electronic mail to the electronic mail address that is included in the personal information or sending a password by ordinary mail to the address that is included in the personal information and then checking whether the password correctly reaches the user.

If it is confirmed in Step S58 that the personal information that was sent from service provider 130b is correct, certificate authority 140a registers the received data fragment Y with database 141a in certificate authority 140a in Step S59.

In Step S60, certificate authority 140a issues a certificate that certifies that the minimum necessary information that can identify the user within the personal information that was received in Step S57 and the public key belong to the user of user terminal 10, and sends this certificate and public key to the user of user terminal 10.

The user of user terminal 10 receives the certificate that has been sent from certificate authority 140a in Step S61.

In Step S62, certificate authority 140a registers the public key that was received in Step S57 and the certificate that was issued in Step S60 in directory 60 and makes public.

However, if it is determined in Step S58 that the personal information that was sent in from service provider 130b is incorrect, the user of user terminal 10 is notified that the personal information is incorrect in Steps S63 and S64.

The data fragments that are registered with database 131b belonging to service provider 130b and database 141a belonging to certificate authority 140a are registered with areas that are closed to the outside by means of the access control function of a server or firewall and cannot be viewed from the outside.

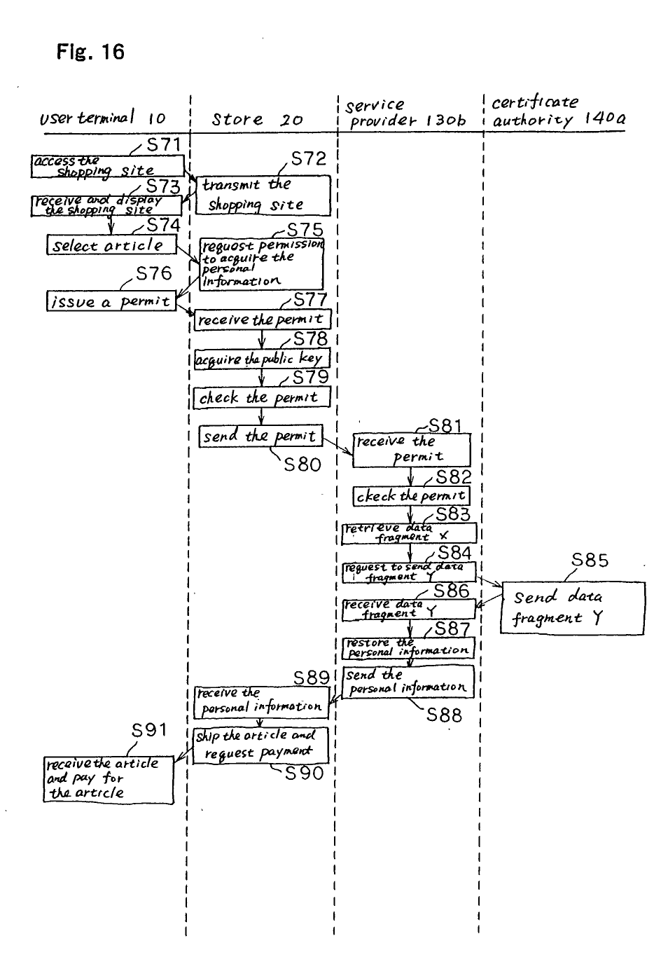

Referring now to FIG. 16, explanation is next presented regarding the process when the user of user terminal 10 uses the personal information that is registered with service provider 130b and certificate authority 140a to purchase an article that is handled by store 20.

When the user of user terminal 10 purchases an article that is handled by store 20, the user first uses user terminal 10 to access the shopping site that is operated by store 20 in Step S71.

The shopping site that is operated by store 20 is then sent from store 20 in Step S72.

The shopping site that has been sent from store 20 is received by way of Internet 50 and displayed on user terminal 10 in Step S73.

In Step S74, the user of user terminal 10 views the shopping site that is displayed on user terminal 10 and selects a desired article.

In Step S75, store 20 lists the items of personal information that are necessary for taking an order for the article that has been selected by the user in Step S74, and requests the user for permission to acquire from database 131b of service provider 130b the personal information relating to the user of user terminal 10 for these items.

The user of user terminal 10 checks the items that have been sent in from store 20, and if the user allows store 20 to acquire the personal information relating to the user of user terminal 10 for these items, creates a permit indicating the permission to acquire personal information, compresses the permit that has been created, and finally, uses the secret key that was created in Step S51 (see FIG. 15) to encrypt the compressed permit and sends this encrypted permit together with the created permit to store 20 in Step S76.

In Step S77, store 20 receives the permit that was sent from user terminal 10 by way of Internet 50, and in Step S78, store 20 acquires the public key that was registered by the user of user terminal 10 from directory 60.

Store 20 then uses the acquired public key to check whether or not the received permit was created by the user of user terminal 10 in Step S79. It is also possible for the user's public key to be sent to store 20 together with the permit that was created in user terminal 10 and the encrypted permit, and for store 20 to then use the public key that has been sent in from user terminal 10 to check the permit. In this case, there is no need for store 20 to acquire the public key from directory 60.

The check of the permit in Step S79 is next explained in detail.

Of the permits that were received in Step S77, store 20 first uses the public key that was acquired in Step S78 to decrypt the encrypted permit. The permit that was sent in from user terminal 10, together with the encrypted permit, is then compressed and this compressed permit is then collated with the decrypted permit. If the results of collation show that the two match, the permit that was received in Step S77 is confirmed to be a permit that was created by the user of user terminal 10. Here, the public key that store 20 acquired from directory 60 is certified to belong to the user of user terminal 10 by the certificate that was issued by certificate authority 140a.

If it is confirmed in Step S79 that the received permit was created by the user of user terminal 10, store 20 sends the permits and the encrypted permit that were received from user terminal 10 to service provider 130b in Step S80.

Service provider 130b, having received the permits that were sent in from store 20 in Step S81, uses the public key of the user of user terminal 10 that is registered with directory 60 to check whether the received permits were created by the user of user terminal 10. This check of the permits may also be realized in the same way as the check of the permits in store 20. In addition, in the check of the permits in service provider 130b, as with the check of permits in store 20, the user's public key may be sent from store 20, and the public key that was sent in from store 20 may be used in service provider 130b.

If it is confirmed in Step S82 that the received permits were created by the user of user terminal 10, service provider 130b retrieves data fragment X of the personal information relating to the user of user terminal 10 from database 131b in Step S83.

Service provider 130b holds as link information the address of certificate authority 140a or identification information that can identify certificate authority 140a, certificate authority 140a being the registration destination of data fragment Y that, by combination with data fragment X that has been retrieved from database 131b, becomes the personal information relating to the user of user terminal 10. Based on this link information, service provider 130b requests certificate authority 140a, which is the registration destination of data fragment Y, for the transmission of data fragment Y in Step S84. When the link information that is held by service provider 130b is identification information that can identify certificate authority 140a, a database that places this identification information in correspondence with the address of certificate authority 140a is further required. In addition, this link information may also be encrypted and then held.

Certificate authority 140a, having received the request from service provider 130b, retrieves data fragment Y from within database 141a and sends data fragment Y to service provider 130b in Step S85.

In Step S87, service provider 130b, having received data fragment Y that has been sent from certificate authority 140a in Step S86, combines data fragment X that has been retrieved from database 131b with data fragment Y that has been sent in from certificate authority 140a, and the personal information relating to the user of user terminal 10 is thereby restored. In addition, information relating to the method of dividing and the method of arranging the divided data was added to each of data fragment X and data fragment Y when the personal information was divided in Step S54 (see FIG. 15), and service provider 130b combines data fragment X and data fragment Y based on this information relating to the method of dividing and the method of arranging that has been added to data fragments X and Y.

Of the restored personal information, service provider 130b sends to store 20 in Step S88 only the personal information relating to the items that were listed by store 20.

Store 20, having received the personal information relating to the user of user terminal 10 that has been sent in from service provider 130b in Step S89, ships the article and bills for the article in Step S90 based on the received personal information and the article information that was selected in Step S74.

In Step S91, the user of user terminal 10 then receives the article that was shipped from store 20 and pays for the article.

Finally, upon completion of the transaction for the article, store 20 deletes the personal information that was acquired from service provider 130b.

In this working example, an example was described in which service provider 130b, which handles the connection of the terminal of store 20 to Internet 50: divides the personal information relating to the user of user terminal 10, registers a portion of this personal information with database 131b, sends the portion of this divided personal information that was not registered with database 131b to certificate authority 140a by way of Internet 50, and further, holds link information that indicates the registration destinations of the portions of divided personal information, authenticates a user by means of data that are sent in from store 20, combines the portion of personal information that was registered with database 131b with the portion of personal information that was sent to certificate authority 140a and registered with database 141a that is provided in certificate authority 140a, and sends the combined personal information to store 20. However, these processes may also be performed in service provider 30a that handles connections of user terminal 10 to Internet 50.

In addition, a configuration is also possible in which, in a service site that provides a site on the Internet: personal information relating to the user of user terminal 10 are divided, a portion of this divided personal information is registered with a database that belongs to the service site, the portion of the divided personal information that was not registered with the database that belongs to the service site is sent by way of Internet 50 to certificate authority 140a, and further, link information that indicates the registration destinations of the portions of divided personal information is held, a user is authenticated by means of data that are sent in from store 20, the portion of personal information that was registered with the database of the service site is combined with the portion of personal information that was sent to certificate authority 140a and registered with database 141a that belongs to certificate authority 140a, and the combined personal information is sent to store 20.

A configuration is also possible in which only link information that indicates the registration destinations of the divided data fragments is held in service provider 130b and a divided data fragment is not registered with service provider 130b, the divided data fragments being registered with each of a plurality of other areas that are connectible to Internet 50 and that include certificate authority 140a.

In the two working examples that have been described in the foregoing explanation, certificate authority 40a or service provider 130b holds link information that indicates the registration destination of data fragment Y, but it is also possible for link information that indicates the registration destination of data fragment Y to be attached to data fragment X. In such a case, even though certificate authority 40a or service provider 130b do not hold link information, the registration destination of data fragment Y can be identified by referring to data fragment X.

Further, rather than creating link information that indicates the registration destination of data fragment Y, it is also possible for certificate authority 40a or service provider 130b to send requests for the transmission of data fragment Y to all certificate authorities that are connected to Internet 50.

Further, in the above-described working examples, personal information was divided between two data fragments, data fragment X and Y, and data fragment X was registered with certificate authority 40a or service provider 130b and data fragment Y was registered with certificate authority 40b or certificate authority 140a. However, it is also possible for the personal information to be divided among three or more data fragments and for each of the data fragments to be registered with different certificate authorities or service providers and then later combined.

Finally, although an example of online shopping for purchasing articles on the Internet was described in the above-described working examples, the present invention is not limited to online shopping but can also be applied to cases in which personal information is registered with areas that are connectible to the Internet and this personal information is then used to realize prescribed processing on the Internet.

While preferred embodiments of the present invention have been described using specific terms, such description is for illustrative purposes only, and it is to be understood that changes and variations may be made without departing from the spirit or scope of the following claims.

What is claimed is:

1. A personal information management system, comprising:
at least one terminal that is connectible to the Internet; and
an authentication means for both using a public key cryptosystem to certify personal information that is registered with areas that are connectible to said Internet and registering said personal information with said areas, and, in response to a request, which is certified by said public key cryptosystem, sending said personal information to the terminal that sent said request;
wherein said authentication means: divides said personal information into a plurality of data portions; registers at least one of said plurality of data portions with a database that is provided in said authentication means; registers the other data portions with other areas that are connectible to said Internet and that are under control that is different from that authentication means; and, when a request, which is certified by said public key cryptosystem, to acquire said personal information is sent in from said terminal, combines said divided plurality of data portions to restore said personal information and sends the personal information to the terminal that sent said request.

2. A personal information management system according to claim 1, wherein said authentication means holds link information that indicates the registration destinations of said other data portions, and, when said request has been sent in, recognizes the registration destinations of said other data portions based on said link information.

3. A personal information management system according to claim 1, wherein said authentication means attaches link information that indicates the registration destinations of said other data portions to the data portion that is registered with a database that is provided in the authentication means.

4. A personal information management system according to claim 1, wherein said authentication means: divides said personal information into a plurality of data portions each of a predetermined fixed length, arranges the plurality of divided data portions in at least two data fragments according to a set method of arranging, and registers each data fragment with a database provided in said authentication means or in said other areas.

5. A personal information management system according to claim 1, wherein said authentication means divides said personal information into a plurality of data portions each of equal arbitrary length, arranges the divided plurality of data portions in at least two data fragments according to a set method of arranging, and registers each data fragment with a database that is provided in said authentication means or in said other areas.

6. A personal information management system according to claim 1, wherein said authentication means divides said personal information into a plurality of data portions each of differing arbitrary length, arranges the plurality of divided data portions in least two data fragments according to a set method of arranging, and registers the data fragments with a database that is provided in said authentication means or in said other areas.

7. A personal information management system according to claim 4, wherein said authentication means attaches information relating to the method of dividing and the method of arranging said personal information to each of said data fragments.

8. A personal information management system according to claim 4, wherein said authentication means encrypts said personal information and divides the encrypted personal information and the encryption key used in the encryption into a plurality of data portions.

9. A personal information management system according to claim 4, wherein said authentication means encrypts each of said data fragments.

10. A personal information management system, comprising:
at least one terminal that is connectible to the Internet;
an authentication means for both using a public key cryptosystem to certify personal information that is registered with areas that are connectible to said Internet and registering said personal information with said areas, and, in response to a request that is certified by said public key cryptosystem, sending said personal information to the terminal that sent said request;
wherein said authentication means: divides said personal information into a plurality of data portions; registers the plurality of data portions with areas that are connectible to said Internet and that are under separate control, and holds link information that indicates the registration destinations of said plurality of data portions; and, when a request, which is certified by said public key cryptosystem, to acquire said personal information is sent in from said terminal, acquires said plurality of data portions that have been divided based on said link information, combines said plurality of data portions that have been acquired to restore said personal information, and sends the personal information to the terminal that sent said request.

11. A personal information management system according to claim 1, wherein at least one of said other areas is another authentication means that uses a public key cryptosystem to certify personal information that is registered with areas that are connectible to said Internet.

12. A personal information management system, comprising:
at least one terminal that is connectible to the Internet;
a service provider for handling connections of said terminal to said Internet; and
an authentication means for using a public key cryptosystem to certify personal information that is registered with areas that are connectible to said Internet;
wherein said service provider: divides said personal information into a plurality of data portions; registers at least one data portion of the plurality of data portions with a database that is provided in the service provider; registers the other data portions with other areas that include a database that is provided in said authentication means, that are connectible to said Internet, and that are under different control than the service provider; and when a request that is certified by means of said public key cryptosystem to acquire said personal information is sent in from said terminal, combines said plurality of divided data portions to restore said personal information and sends the personal information to the terminal that sent said request.

13. A personal information management system according to claim 12, wherein said service provider holds link information that indicates the registration destinations of said other data portions, and, when said request is sent in, identifies the registration destinations of said other data portions based on said link information.

14. A personal information management system according to claim 12, wherein said service provider attaches link information that indicates the registration destinations of said other data portions to the data portion that is registered with a database that is provided in said service provider.

15. A personal information management system according to claim 12, wherein said service provider divides said personal information into a plurality of data portions each of a predetermined fixed length, arranges the divided plurality of data portions in at least two data fragments according to a set method of arranging, and registers each data fragment with a database provided in said service provider or in said other areas.

16. A personal information management system according to claim 12, wherein said service provider divides said personal information into a plurality of data portions each of equal arbitrary length, arranges the plurality of divided data portions in at least two data fragments according to a set method of arranging, and registers each data fragment with a database that is provided in said service provider or in said other areas.

17. A personal information management system according to claim 12, wherein said service provider divides said personal information into a plurality of data portions each of differing arbitrary length, arranges the plurality of divided data portions at least two data fragments according to a set method of arrangement, and registers the data fragments in a database that is provided with said service provider or in said other areas.

18. A personal information management system according to claim 15, wherein said service provider attaches information relating to the method of dividing and the method of arranging said personal information to each of said data fragments.

19. A personal information management system according to claim 15, wherein said service provider encrypts said personal information, and divides the encrypted personal information and the encryption key used in the encryption into a plurality of data portions.

20. A personal information management system according to claim 15, wherein said service provider encrypts each of said data fragments.

21. A personal information management system, comprising:
at least one terminal that is connectible to the Internet;
a service provider for handling connections of said terminal to said Internet; and
an authentication means for using a public key cryptosystem to certify personal information that is registered with areas that are connectible to said Internet;
wherein said service provider: divides said personal information into a plurality of data portions; registers the plurality of data portions with areas that are connectible to said Internet and that are under different control each other; holds link information that indicates the registration destinations of said plurality of data portions; and when a request that is certified by means of said public key cryptosystem to acquire said personal information is sent in from said terminal, acquires said plurality of divided data portions based on said link information, combines the acquired plurality of data portions to restore said personal information, and sends the personal information to the terminal that sent said request.

22. A personal information management method, comprising steps of:
dividing personal information into a plurality of data portions;
arranging the plurality of data portions in at least two data fragments and registering each data fragment with areas that are connectible to the Internet and that are under different control;
combining said plurality of divided data portions to restore said personal information when a request to acquire said personal information is outputted, said request being certified by means of a public key cryptosystem, and
sending said restored personal information to the originator of said request.

23. A personal information management method according to claim 22, further comprising steps of:
holding link information that indicates the registration destinations of other data fragments in at least one area of the areas in which said data fragments are registered; and
identifying the registration destinations of said other data fragments based on said link information when said request is issued.

24. A personal information management method according to claim 22, further comprising steps of:
attaching to said data fragments link information that indicates the registration destinations of other data fragments; and
identifying the registration destinations of said other data fragments based on said link information when said request is issued.

25. A personal information management method according to claim 22, wherein said personal information is divided into a plurality of data portions by dividing said personal information into a plurality of data portions each of predetermined fixed lengths.

26. A personal information management method according to claim 22, wherein said personal information is divided into a plurality of data portions by dividing said personal information into a plurality of data portions each of equal arbitrary lengths.

27. A personal information management method according to claim 22, wherein said personal information is dividend into a plurality of data portions by dividing said personal information into a plurality of data portions each of different arbitrary lengths.

28. A personal information management method according to claim 25, further comprising a step of attaching, to each of said data fragments, information relating to the method of dividing said personal information.

29. A personal information management method according to claim 25, further comprising a step of encrypting said personal information;
wherein the encrypted personal information and the encryption key that was used in encryption are divided into a plurality of data portions to divide among a plurality of data portions of said personal information.

30. A personal information management method according to claim 25, further comprising a step of encrypting each of said data fragments.

31. An information processing server that is provided in an authentication means for both using a public key cryptosystem to certify personal information that is registered with areas that are connectible to the Internet and registering said personal information with said areas, and, in response to a request that is certified by said public key cryptosystem, sending said personal information to the originator of said request; said information processing server comprising:
a dividing means for dividing said personal information into a plurality of data portions, registering at least one data portion of the plurality of data portions with a database that is provided in said authentication means, and registering the other data portions with other areas that are connectible to said Internet that are under control that is different from said authentication means;
a restoring means for, when a request that is certified by said public key cryptosystem to acquire said personal information is sent in, combining said plurality of divided data portions to restore said personal information; and
transmission means for sending the personal information that has been restored by said restoring means to the originator of said request.

32. An information processing server according to claim 31, wherein said restoring means holds link information that indicates the registration destinations of said other data portions, and, when said request is sent in, identifies the registration destinations of said other data portions based on said link information.

33. An information processing server according to claim 31, wherein said dividing means attaches, to data that are registered with a database that is provided in said authentication means, link information that indicates the registration destinations of said other data portions.

34. An information processing server according to claim 31, wherein said dividing means divides said personal information into a plurality of data portions each of a predetermined fixed length, arranges the plurality of divided data portions among at least two data fragments according to a set method of arranging, and registers each data fragment with a database that is provided in said authentication means or in said other areas.

35. An information processing server according to claim 31, wherein said dividing means divides said personal information into a plurality of data portions each of equal arbitrary length, arranges the plurality of divided data portions among at least two data fragments according to a set method of arranging, and registers each data fragment with a database that is provided in said authentication means or in said other areas.

36. An information processing server according to claim 31, wherein said dividing means divides said personal information into a plurality of data portions each of different arbitrary length, arranges the plurality of divided data portions among at least two data fragments according to a set method of arranging, and registers each data fragment with a database that is provided in said authentication means or in said other areas.

37. An information processing server according to claim 34, wherein said dividing means attaches to each of said data fragments information relating to the method of dividing and the method of arranging said personal information.

38. An information processing server according to claim 34, wherein said dividing means encrypts said personal information and divides the encrypted personal information and the encryption key used in the encryption into a plurality of data portions.

39 An information processing server according to claim 34, wherein said dividing means encrypts each of said data fragments.

40. An information processing server that is provided in an authentication means for both using a public key cryptosystem to certify personal information that is registered with areas that are connectible to the Internet and registering said personal information with said areas, and, in response to a request that is certified by said public key cryptosystem, sending said personal information to the originator of said request; said information processing server comprising:
a dividing means for dividing said personal information into a plurality of data portions and registering the plurality of data portions with areas that are connectible to said Internet and that are under separate control;
a restoring means for holding link information that indicates the registration destinations of said plurality of data portions, and, when a request to acquire said personal information is sent in from said terminal, said request being certified by said public key cryptosystem, acquiring said plurality of divided data portions based on said link information, combining said acquired plurality of data portions to restore said personal information; and
transmission means for sending the personal information that has been restored by said restoring means to the terminal that sent said request.

41. An information processing server that is provided in service provider that handles connections of a terminal that is connectible to the Internet to said Internet, said information processing server comprising:
a dividing means for dividing said personal information into a plurality of data portions and registering at least one data portion of the plurality of data portions with a database that is provided in said service provider, and registering the other data portions with areas that are connectible to said Internet, that are under control that is different from said service provider, and that include the database that is provided in an authentication means that uses a public key cryptosystem to certify personal information that is registered on said Internet;
a restoring means for, when a request to acquire said personal information is sent in from said terminal, said request being certified by said public key cryptosystem, combining said divided plurality of data portions to restore said personal information; and
transmission means for sending the personal information that has been restored by said restoring means to the terminal that sent said request.

42. An information processing server according to claim 41, wherein said restoring means holds link information that indicates the registration destinations of said other data portions, and, when said request has been sent in, identifying the registration destinations of said other data portions based on said link information.

43. An information processing server according to claim 41, wherein said dividing means attaches, to data portions that are registered with the database that is provided in said service provider, information that indicates the registration destinations of said other data portions.

44. An information processing server according to claim 41, wherein said dividing means divides said personal information into a plurality of data portions each of a predetermined fixed length; arranges the plurality of divided data portions among at least two data fragments according to a set method of arranging, and registers each of the data fragments with a database that is provided in said service provider or in said other areas.

45. An information processing server according to claim 41, wherein said dividing means divides said personal information into a plurality of data portions each of equal arbitrary length, arranges the plurality of divided data portions among at least two data fragments according to a set method of arranging, and registers each of the data fragments with a database that is provided in said service provider or in said other areas.

46. An information processing server according to claim 41, wherein said dividing means divides said personal information into a plurality of data portions each of a different arbitrary length, arranges the plurality of divided data portions among at least two data fragments according to a set method of arranging, and registers each data fragment with a database that is provided in said service provider or in said other areas.

47. An information processing server according to claim 44, wherein said dividing means attaches to each of said data fragments information relating to the method of dividing and the method of arranging said personal information.

48. An information processing server according to claim 44, wherein said dividing means encrypts said personal information and divides the encrypted personal information and the encryption key used in encryption into a plurality of data portions.

49. An information processing server according to claim 44, wherein said dividing means encrypts each of said data fragments.

50. An information processing server that is provided in a service provider for handling connections of a terminal that is connectible to the Internet to said Internet, said information processing server comprising:
dividing means for dividing said personal information into a plurality of data portions and registering the plurality of data portions with areas that are connectible to said Internet and that are under separate control;
a restoring means for holding link information that indicates the registration destinations of said plurality of data portions; and, when a request to acquire said personal information is sent in from said terminal, said request being certified by said public key cryptosystem, acquiring said plurality of divided data portions based on said link information, and combining the plurality of data portions that have been acquired to restore said personal information; and
a transmission means for sending the personal information that has been restored by said restoring means to the terminal that sent said request.
